(19) United States
(12) Patent Application Publication
(10) Pub. No.: US 2024/0370931 A1
(43) Pub. Date: Nov. 7, 2024

(54) PERSONALIZED FINANCIAL NEWSLETTER GENERATION SYSTEM BASED ON USER DEMOGRAPHIC, INTERESTS, AND PORTFOLIO COMPOSITION

(71) Applicant: Nowcasting.ai, Inc., Palo Alto, CA (US)

(72) Inventor: Damiàn Ariel SCAVO, Menlo Park, CA (US)

(21) Appl. No.: 18/653,766

(22) Filed: May 2, 2024

Related U.S. Application Data
(60) Provisional application No. 63/463,429, filed on May 2, 2023.

(51) Int. Cl. G06Q 40/06; G06F 40/103; G06F 40/166; G06F 40/58

(52) U.S. Cl. CPC G06Q 40/06; G06F 40/103; G06F 40/166; G06F 40/58

(57) ABSTRACT

A method for generating a personalized newsletter. The method may include receiving and analyzing news articles from various sources in real-time or at predetermined intervals; storing and managing user demographic information, financial portfolio data, interests, preferences, and financial education levels; processing the analyzed news articles and user information using a Generative Artificial Intelligence (AI) to create personalized content based on the user's demographic information, financial portfolio, interests, preferences, and financial education level; assembling the personalized content into a newsletter with varying lengths and details tailored to the user; and sending the personalized newsletter to the user via email or other communication methods, wherein the tone and style of the personalized content are adjusted based on the user's preferences.

### CROSS-REFERENCE TO RELATED APPLICATIONS

This application claims priority under 35 USC § 119 (a) to U.S. Provisional Application No. 63/463,429, filed on May 2, 2023, the contents of which are incorporated herein by reference in their entireties.

### BACKGROUND

### Field

The present invention relates to the field of personalized content generation, and more particularly to an automated system for generating customized newsletters tailored to individual user preferences, demographics, and financial portfolios, using Generative Artificial Intelligence (AI) and real-time news analysis.

### Related Art

With the increasing volume of information available online, it has become difficult for users to keep up with news and developments relevant to their interests and financial portfolios. Traditional newsletters, whether daily or hourly, often fail to cater to the specific needs and preferences of each user, resulting in a generic and less engaging experience.

Moreover, the tone and reporting style of these newsletters often do not match the user's preferences and may not be suitable for the user's level of financial education or understanding. There is a need for a system that can generate personalized newsletters that not only deliver relevant and timely information but also cater to the unique preferences, demographics, and financial portfolios of individual users.

### SUMMARY

The present invention addresses the aforementioned needs by providing a system for generating personalized newsletters based on the user's demographic information, personal preferences, and financial portfolio. The system utilizes Generative AI algorithms to analyze global news in real-time and at fixed intervals, taking into consideration factors such as the user's interests, level of financial education, age, gender, wealth, and personal tastes to produce a customized newsletter with varying lengths and details.

Accordingly, one aspect of the present invention is a system for generating personalized newsletter. The system may include a real-time news analysis module configured to receive, analyze, and categorize news articles from various sources in real-time or at predetermined intervals; a user information module configured to store and manage user demographic information, financial portfolio data, interests, preferences, and financial education levels; a Generative Artificial Intelligence (AI) module configured to process the analyzed news articles and user information to create personalized content based on the user's demographic information, financial portfolio, interests, preferences, and financial education level; a newsletter generator module configured to assemble the personalized content into a newsletter with varying lengths and details tailored to the user; and a communication module configured to send the personalized newsletter to the user via email or other communication methods, wherein the tone and reporting style of the personalized content are adjusted based on the user's preferences.

Accordingly, one aspect of the present invention is a method for generating personalized newsletter. The method may include receiving and analyzing news articles from various sources in real-time or at predetermined intervals; storing and managing user demographic information, financial portfolio data, interests, preferences, and financial education levels; processing the analyzed news articles and user information using a Generative Artificial Intelligence (AI) to create personalized content based on the user's demographic information, financial portfolio, interests, preferences, and financial education level; assembling the personalized content into a newsletter with varying lengths and details tailored to the user; and sending the personalized newsletter to the user via email or other communication methods, wherein the tone and reporting style of the personalized content are adjusted based on the user's preferences.

Accordingly, one aspect of the present invention is a method for generating personalized newsletter. The method may include collecting and processing, by a processor, news articles from various sources; retrieving, by the processor, user profile information associated with a user stored in a database; generating, by the processor, personalized content information by using the user profile information and processed news articles as input to a generative Artificial Intelligence (AI) model; and formatting, by the processor, the personalized content information into a newsletter tailored to the user for review

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example personalized newsletter generation system 100, in accordance with an example implementation.

FIG. 2 illustrates an example environment 200 in which personalized newsletter generation system 100 is implemented on a server, in accordance with an example implementation.

FIG. 3 illustrates an example process flow 300 of personalized newsletter generation using the personalized newsletter generation system 100 of FIG. 1, in accordance with an example implementation.

FIG. 4 illustrates an example computing environment with an example computer device suitable for use in some example implementations.

FIG. 5 illustrates an example process 500 directed to execution of an order based on a single user action, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations relate to an integrated personalized newsletter generation system designed to provide users with personalized newsletter based on their unique preferences and profiles. The system leverages advanced artificial intelligence (AI), real-time news data, and exclusive datasets to deliver custom contents and newsletters to users.

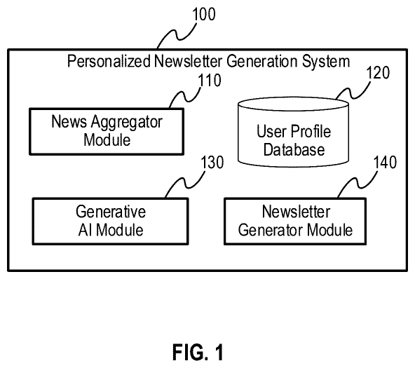

FIG. 1 illustrates an example personalized newsletter generation system 100, in accordance with an example implementation. As illustrated in FIG. 1, the personalized newsletter generation system 100 may include components such as, but not limited to, a news aggregator module 110, a user profile database 120, a Generative AI module 130, and a newsletter generator module 140.

The news aggregator module 110 collects and processes global news data from various sources in real-time and/or at fixed intervals. In some example implementations, the collection period can be set according to user preference (e.g., specified time, frequency, etc.). The news aggregator module 110 can filter and categorize the news based on one or more of predefined topics and sectors, user interests, financial portfolio information, etc. The user profile database 120 stores user data such as, but not limited to, demographic information, personal preferences, financial portfolio information, etc. The user profile database 120 can be updated periodically or in real-time as the user's preferences and portfolio change. In some example implementations, acronym usage (e.g., remove, increase, reduce, expand, etc.) in the user profile information can be modified based on the educational level and preferences of the user.

The Generative AI module 130 processes the news data received from the news aggregator module 110 using a Generative AI model and generates personalized content based on the user's profile and preferences stored in the user profile database 120. The Generative AI module 130 can create content with varying voice tones, educational levels, and personal styles to ensure a personalized experience for each user. In some example implementations, the Generative AI module 130 translates received news data in a first language to a second language personal/native to the user and then performs content generation on the translated news data. Training of the Generative AI model is performed using back-propagation

The Generative AI module 130 may utilize any one or combination of a variety of different models in generating personalized contents/news segments, including but not limited to generative adversarial networks (GANs), variational auto-encoders (VAEs), auto-regressive models, transformers, etc. In some example implementations, the AI model is a large multimodal language model that works with different types of input data, such as text, images, audio, video, etc. The news data is received at an input layer of the Generative AI model, and processed at a hidden layer of the Generative AI model to generate personalized content/news segment based on the user's profile and preferences. The personalized content/news segment is then output from an output layer of the Generative AI model for additional processing.

In some example implementations, the system can adjust/assign a tone and a reporting style of the personalized content based on the content category and the user's preferences. Different tones and/or reporting styles (e.g., real person's tone/speech style, tone/speech style reminiscent of a fictional character, etc.) may be implemented for personalized contents of different categories. For example, for a user who is a 40-year-old fan of Marvel and has a tech-heavy financial portfolio, the system could use a voice tone reminiscent of Tony Stark to deliver detailed audio financial news on their portfolio and relevant sectors. For a 21-year-old woman interested in luxury products and with a consumer brand-focused portfolio, the system could use a voice tone similar to Michelle Obama, focusing on the most important news of the day with a more emotional and less number-driven approach. In some example implementations, the personalized content comprises both an audio content and a textual content.

The newsletter generator module 140 combines the personalized content generated by the Generative AI module 130 and formats it into a newsletter. The newsletter generator module 140 can create newsletters with varying lengths and details based on the user's preferences and needs. The system then sends the newsletter to the user via email or other communication methods, and/or to a user device for the user to review.

Present implementations can be implemented as a software application, a web service, or an API that can be integrated into other systems or platforms, such as asset management systems, broker platforms, or investment advisory dashboards.

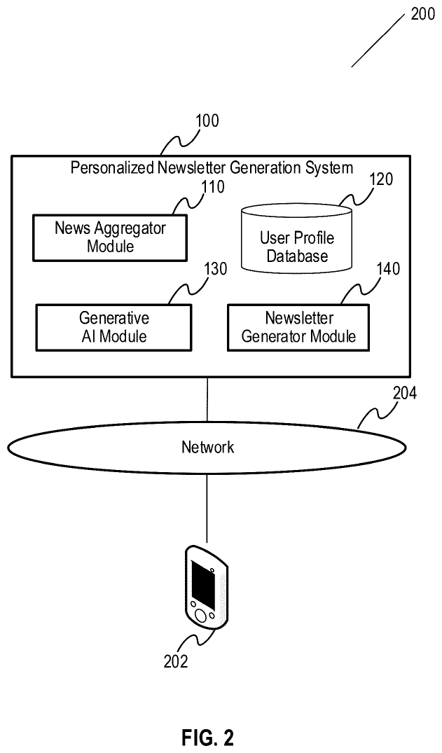

In some example implementations, user data is generated through user input on a user device, which may be a computer, a smartphone, a smart device, etc. FIG. 2 illustrates an example environment 200 in which the personalized newsletter generation system 100 is implemented on a server, in accordance with an example implementation. As illustrated in FIG. 2, environment 200 may include a user device 202 and the personalized newsletter generation system 100 implemented as a server. The user device 202 communicates with the personalized newsletter generation system 100 through a network 204. Network 204 can be any network or combination of networks (e.g. internet, local area network, wide area network, telephonic network, cellular network, satellite network, etc.)

The user device 202 may receive input/request from a user for generation of user data through a graphical user interface (GUI). Examples of user device 202 may include, but not limited to mobile devices (e.g., smartphones, devices in vehicle and other machine, tablets, notebooks, laptops, personal computers, etc.), and devices not designed for mobility (e.g., desktop computers, information kiosks, televisions, etc.). The generated user data is then communicated through the network 204 to the personalized newsletter generation system 100, to be stored in the user profile database 120. In some example implementations, the user may enter user preferences, user settings, and risk levels into the user device 202, which will then be used in personalized newsletter formulation.

In some example implementations, distributed computing may be performed to generate personalized newsletter at user devices 202. Specifically, a number of user devices 202 may be utilized to perform distributed computing when server/the personalized newsletter generation system 100's resources are exhausted causing it to be overloaded. The number of user devices 202 may be used to generate personalized newsletter locally when Generative AI is installed or accessed, and providing the generated personalized newsletter to the requesting user device 202. Permission of the user may be needed before the number of user devices 202 can access information pertaining to request for personalized newsletter.

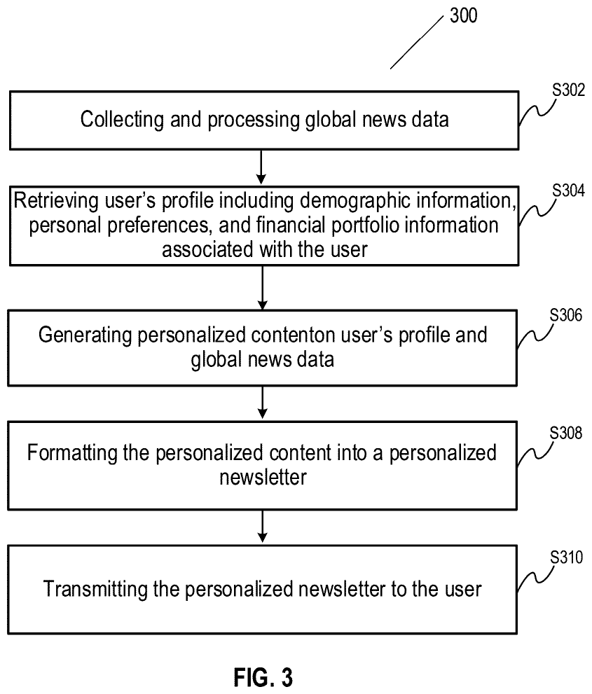

FIG. 3 illustrates an example process flow 300 of personalized newsletter generation using the personalized newsletter generation system 100 of FIG. 1, in accordance with an example implementation. As illustrated in FIG. 3, the process begins at step S302, where global news data is collected and processed using the news aggregator module 110. At step S304, user's demographic information, personal preferences, and financial portfolio information are retrieved from the user profile database 120. At step S306 personalized content is generated based on the user's profile, preferences, and news data using the Generative AI module 130. The Generative AI module 130 may utilize any one or combination of a variety of different models in generating strategies/responses, including but not limited to generative adversarial networks (GANs), variational auto-encoders (VAEs), auto-regressive models, transformers, etc.

At step S308, personalized content is formatted into a personalized newsletter using the newsletter generator module 140. At step S310, the personalist newsletter is transmitted to the user. The personalized newsletter may be transmitted to the user by having the personalized newsletter displayed on the user device 202, sent to the user via email, or delivered to the user through other communication methods.

The example implementations described herein may be executed in the form of machine-readable executable instructions stored in a memory, which are configured to access the predefined user settings, which may be stored, such as in the user profile database 120, either locally or remotely in the cloud for example, such that the user settings may be accessed by one or more devices as are authorized by the user to execute the instructions. Instructions may also be provided in the form of an online user application.

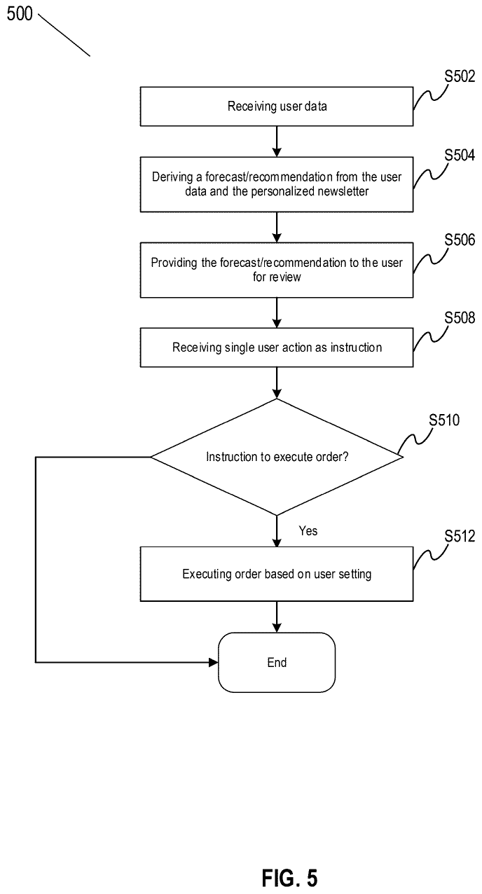

FIG. 5 illustrates an example process 500 associated with the foregoing example implementations. More specifically, the example process 500 is directed to execution of an order based on a single user action, wherein the order is based on a received forecast/recommendation. The process begins at step S502 where user data is received. At step S504, a forecast/recommendation is derived from the user data and the personalized newsletter. In some example implementations, the forecast/recommendation may be generated from the personalized newsletter and user data such as, but not limited to, demographic information, personal preferences, user setting, financial portfolio information, etc., as stored in the user profile database 120.

Specifically, the forecast/recommendation may be derived using the personalized newsletter and the user data as input to an input layer of the Generative AI model 130. The received information/data is then processed at a hidden layer of the Generative AI model 130 to generate personalized forecast/recommendation based on observed trend and the user's profile and preferences. The personalized content/news segment is then output from an output layer of the Generative AI model 130 for user's review and selection.

At step S506, the forecast/recommendation is then provided to the user in the form of a push notification, such as SMS, email or the like, on the user device 202 for review. At step S508, a single user instruction is received. The single-user instruction is based on a single user action. For example, but not by way of limitation, the single-user action is the user selecting “yes” or “no”. This may be done, as explained above by visual or audio input to the user device 202, which may include a mobile phone, a laptop, etc., as also explained above. At step S510, a determination is made as to the instruction associated with the single-user action. For example, but not by way of limitation, it is determined whether the single user action is to execute the order or not execute the order. If the operation at step S510 determines that the single user action is an instruction to not execute the order, the process terminates.

On the other hand, if the single user action is determined to be an instruction to execute the order, then at step S512, the order is executed based on user preference/setting that was received at step S502 as part of the user data. The user must determine only whether to execute an order based on the provided forecast/recommendation. If the user has included, in his or her user settings, a default setting to immediately execute the order based on chosen recommendation, then the order will be submitted as soon as the user makes selection (e.g., single user selection/action on the user device 202, etc.) without delay. Once the selection is made, the order can then be placed automatically without further user input or review. In alternate example implementation, the order may be executed across a time period, such as the business day. According to one example implementation, a user may include in his or her user preferences, a default setting to make a purchase for a prescribed amount, such as $1 million, at even intervals over the course of the day. The user preference/setting provides information that is, including but not limited to, whether the order is executed immediately or at a later time; whether the order is executed as a single transaction or a plurality of transactions; whether, if a plurality of transactions is requested; whether the timing and amount are evenly or unevenly distributed over the course of a day or other time period; and whether there are any price limits or other limits, or patterns in the case of an uneven distribution over the course of the day or other time period, and identity of one or more brokers or markets that constitute service providers, or other user settings as explained above. Thus, the order is executed based on a single user action, in association with the user settings.

Similarly, the user settings may provide an order limit in the default, such that if the price exceeds a price limit, the order is no longer executed for the rest of the day. Thus, according to one example implementation, if a user selects “yes” to purchase $1000 of a stock divided evenly over five hours, with a $200 order being placed every hour, and the stock price then exceeds the limit price during the third hour, then the fourth hour order of $200 will not be executed if the stock price continues to exceed the limit price. Similarly, at the fifth hour, if the stock price exceeds the limit price, that fifth hour order will not be placed.

With respect to the execution of the order, the user may provide, in the default settings, one or more default service providers, such as one or more brokers. Further, the user may provide one or more stock exchanges upon which to execute the order. The user may specify a percentage of an overall order to be placed with each of the one or more brokers that is even, uneven, or proportionally divided automatically based on past performance relative to past recommendations.

As for the order size, the user default setting may provide for a predetermined order size, such as 100 shares, or a predetermined amount, such as $1000 worth of shares. Thus, the user need not specify the number of shares; the amount of the shares; which broker or brokers or stock exchanges to contact; the timing of the order placement and execution; the proportionality or evenness of the timing or amounts over a time, because those parameters are already determined based on the previously provided user settings. Accordingly, the user only needs to select “yes” or “no” (e.g., as appeared on the user device 102), to execute the order according to the default user settings as previously determined by the user.

In some example implementations, the user may receive one or more forecasts/recommendations in the form of push notification. In addition to a one-to-one relationship between the user action and the trade execution, the user may be provided with an option to execute all of the multiple push notifications that are provided together, with a single decision, by selecting an option such as “yes to all”. If such an option is selected, then all of the orders will be executed according to the predefined user preferences as explained above.

The foregoing example implementations may provide a push notification by modes known to those skilled in the art. For example, but not by way of limitation, the push notification may be provided by email, text message or SMS (short message service), chat via online social networking service, etc. Further, the push notification may be provided not just in a visual presentation, but alternatively or conjunctively as an audio message, such as by a speaker in a home device, such as AMAZON ALEXA or the like.

Further, the foregoing example implementations may provide the option of performing order execution during transport, such as to a driver receiving the signals via a telecommunications network including but not limited to a 5G network. Thus, the driver, by audio communication with a speaker and microphone or other input/output devices that would be understood by those skilled in the art, may execute, by a single voice command, the instruction to execute the order as explained above. Similarly, a passenger may also use the system. Thus, the example implementations may provide for hands-free order placement.

Additionally, while the example implementations may be implemented on a mobile communication device such as a smart phone, the example implementations are not limited thereto. For example, but not by way of limitation, the user settings may provide the user with control over the single action purchase modes, so as to require the user to join from an authenticated device, such as by requiring two factor authentication prior to accessing the strategies/responses, or the push notifications, or to provide a privacy preserving aspect, such that other form of authentication, such as login, biometric, second factor, or other aspect is required to receive the push notification. Similarly, in place of the user providing an audio response or selecting a specific option on a screen, the user may instead use gestures, signals, or other biometrics to indicate a decision.

For example, but not way of limitation, the user may determine that, in the user settings, if the first finger is placed on a fingerprint detector associated with the user device 202, then the user is indicating that the order should be executed in accordance with the forecast/recommendation provided; whereas, if a finger other than the first finger is placed on a fingerprint detector, then the user is indicating that the order should not be executed. Such an example implementation would allow the user to make his or her decision in the presence of other individuals who, although they may be able to hear or see the user interface, cannot understand whether the single action of the user is a decision to execute the order not to execute the order. While the foregoing example refers to a fingerprint, other gesture or user signal as defined in the user settings may be employed. Similarly, a voice command other than “yes” or “no” may also be used, so as to prevent a third party from knowing what the user has decided to do simply based on hearing the audio response of the user. Thus, the privacy of the user is protected in circumstances where the user interface can be seen or heard by others.

In terms of hardware, the foregoing example implementations may be implemented in a client device such as a smart phone, laptop or the like. Further, and as also explained herein, the foregoing example implementations may be integrated with other devices, such as a device, a processor and memory of an automobile or other vehicle, or other device as would be understood by those skilled in the art. The foregoing user experiences may be provided by the user in a “user setting” aspect of an online application as parameters that are input by text entry, radio button, checkbox, slider or other visual manner of user input and user output as would be understood by those skilled in the art.

The example implementations described herein may be executed in the form of machine-readable executable instructions stored in a memory, which are configured to access the predefined user settings, which may be stored, such as in the database 140, either locally or remotely in the cloud for example, such that the user settings may be accessed by one or more devices as are authorized by the user to execute the instructions. Instructions may also be provided in the form of an online user application.

Before the foregoing example implementations are executed to provide the push notification, the user must enter the default user settings. When the online application is installed, a default series of settings may be provided based on a profile of information associated with the user. For example, but not by way of limitation, if the user self identifies their risk level as high, medium or low, then a default setting may be selected from a corresponding set of predefined profiles, based on aggregated information of other users in association with their risk profiles, to match the default setting of the user with an average default setting for other users having a similar risk profile. Factors other than the risk may be used to determine the default settings.

Additionally, the user may have multiple default settings, and different default settings may be applied depending on different user situations that may be automatically accessed by the online application. For example, but not by way of limitation, if the online application is aware that the available cash funds of a user in their bank accounts exceeds a prescribed level, the default settings may be set to one of the default settings in which the amounts, frequency, price limit or other aspect of the user settings are adjusted to account for an increased availability of investment funds, or an increased risk profile.

Optionally, a user may adjust the settings depending on a date for time, such as before or after earnings announcements, start/end of fiscal year, or other critical timing as would be understood by those skilled in the art. Similarly, the timing may be based on a condition of the user, such as after employer payday, after monthly debt payment such as mortgage, credit card, etc. Similarly, the user may be prompted to select a change among the default settings based on a change in the user's financial situation, such as new job, layoff, major purchase such as home or vehicle, vacation, or other financial event. Thus, the user's selection of a default setting may be partially or completely supported, or automated. Alternatively, instead of inputting one or more user settings, the user may generate a rule base that is applied to the user settings, or that is applied directly to the “yes” decision on a push notification.

Step S512 may further include performance of an update to the user financial portfolio, so as to indicate that the order has been executed. Optionally, the user may be provided with a report via the communication or distribution channels explained above, to confirm that the order was executed, to provide an update of the portfolio, and/or to remind the user of any pending or open orders. External data fetching according to the example implementations described herein may be performed by copying data from an external third party (e.g., vendor), and storing the data in a cloud storage container. The data fetching process may be managed by a scheduling server, and/or a serverless compute service that executes operations to manage the external data storage and the associated compute resources. Further, the extraction, transformation and loading of data as described herein may be executed by a batch management processor or service. Batch computing is the execution of a series of executable instructions (“jobs”) on one or more processors without manual intervention by a user, e.g., automatically. Input parameters may be pre-defined through scripts, command-line arguments, control files, or job control language. A batch job may be associated with completion of preceding jobs, or the availability of certain inputs. Thus, the sequencing and scheduling of multiple jobs is critical. Optionally, batch processing may not be performed with interactive processing. For example, the batch management processor or service may permit a user to create a job queue and job definition, and then to execute the job definition and review the results. According to an example implementation, a batch cluster includes 256 CPUs, and an ETL-dedicated server having 64 cores and 312 GB of RAM. The number of running instances may be 1. The foregoing ETL infrastructure may also be applied to the process of insight extraction. Further, an API is provided for data access. For example, but not by way of limitation, the REST API, which conforms to a REST style architecture and allows for interaction with RESTful resources, may be executed on a service. The service may include, but is not limited to, hardware such as 1 vCPU, 2 GB RAM, 10 GB SSD disk, and a minimum of two running instances. The API may be exposed to the Internet via an online application load balancer, which is elastic and permits configuration and routing of an incoming end-user to online applications based in the cloud, optionally pushing traffic across multiple targets in multiple availability zones. The caching layer may be provided by a fast content delivery network (CDN) service, which may securely deliver the data described herein with low latency and high transfer speeds. According to the example implementations, containers may be run without having to manage servers or clusters of instances, such that there is no need to provision, configure, or scale clusters on virtual machines to execute operations associated with containers.

In some example implementations, the personalized newsletter generation system 100 provides a social-sharing feature that allows users to share their personalized newsletters with others. The newsletter recipients may then copy the shared newsletters and issue a commission to the user for sharing the newsletters through the personalized newsletter generation system 100. Receipt or issuance of commissions by users is controlled by the personalized newsletter generation system 100.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the invention.

The foregoing example implementation may have various benefits and advantages. For example, example implementations generate personalized newsletters that conform with users' preferences based on users' demographic information, personal preferences, and financial portfolio. Through Generative AI algorithms, global news can be analyzed in real-time, while taking factors such as the user's interests, level of financial education, age, gender, wealth, and personal tastes into consideration in producing customized newsletters with varying lengths and details.

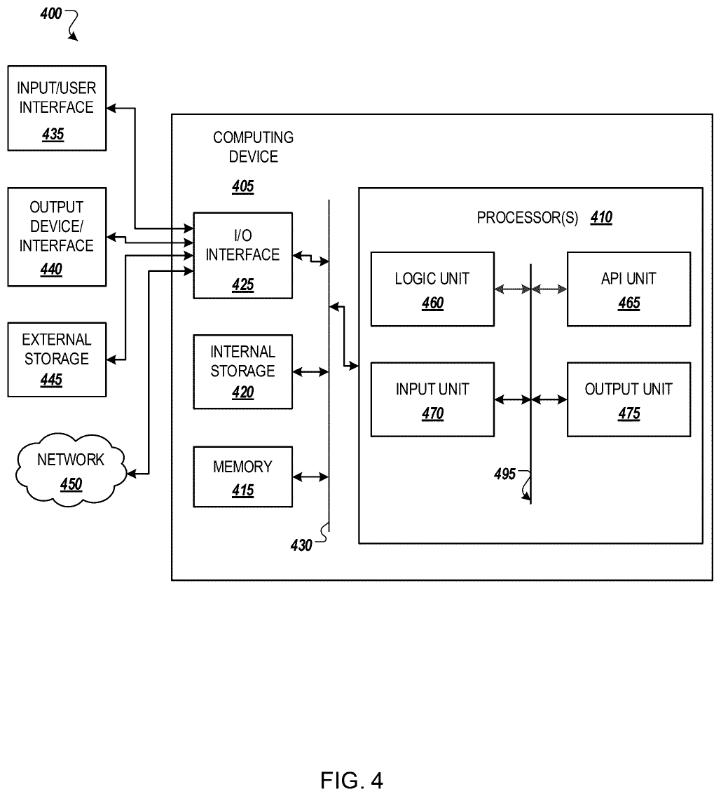

FIG. 4 illustrates an example computing environment with an example computer device suitable for use in some example implementations. Computer device 405 in computing environment 400 can include one or more processing units, cores, or processors 410, memory 415 (e.g., RAM, ROM, and/or the like), internal storage 420 (e.g., magnetic, optical, solid-state storage, and/or organic), and/or IO interface 425, any of which can be coupled on a communication mechanism or bus 430 for communicating information or embedded in the computer device 405. IO interface 425 is also configured to receive images from cameras or provide images to projectors or displays, depending on the desired implementation. Computing environments of User device 102 and management server 106 may be represented by the computing environment of FIG. 4

Computer device 405 can be communicatively coupled to input/user interface 435 and output device/interface 440. Either one or both of the input/user interface 435 and output device/interface 440 can be a wired or wireless interface and can be detachable. Input/user interface 435 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 440 may include a display, television, monitor, printer, speaker, braille, or the like. In some example implementations, input/user interface 435 and output device/interface 440 can be embedded with or physically coupled to the computer device 405. In other example implementations, other computer devices may function as or provide the functions of input/user interface 435 and output device/interface 440 for a computer device 405.

Examples of computer device 405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 405 can be communicatively coupled (e.g., via IO interface 425) to external storage 445 and network 450 for communicating with any number of networked components, devices, and systems, including one or more computer devices of the same or different configuration. Computer device 405 or any connected computer device can be functioning as, providing services of, or referred to as a server, client, thin server, general machine, special-purpose machine, or another label.

IO interface 425 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 400. Network 450 can be any network or combination of networks (e.g., the Internet, local area network, wide area network, a telephonic network, a cellular network, satellite network, and the like).

Computer device 405 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 410 can execute under any operating system (OS) (not shown), in a native or virtual environment. One or more applications can be deployed that include logic unit 460, application programming interface (API) unit 465, input unit 470, output unit 475, and inter-unit communication mechanism 495 for the different units to communicate with each other, with the OS, and with other applications (not shown). The described units and elements can be varied in design, function, configuration, or implementation and are not limited to the descriptions provided. Processor(s) 410 can be in the form of hardware processors such as central processing units (CPUs) or in a combination of hardware and software units.

In some example implementations, when information or an execution instruction is received by API unit 465, it may be communicated to one or more other units (e.g., logic unit 460, input unit 470, output unit 475). In some instances, logic unit 460 may be configured to control the information flow among the units and direct the services provided by API unit 465, the input unit 470, the output unit 475, in some example implementations described above. For example, the flow of one or more processes or implementations may be controlled by logic unit 460 alone or in conjunction with API unit 465. The input unit 470 may be configured to obtain input for the calculations described in the example implementations, and the output unit 475 may be configured to provide an output based on the calculations described in example implementations.

Processor(s) 410 can be configured to collect and process news articles from various sources as shown in FIG. 3. The processor(s) 410 may also be configured to retrieve user profile information associated with a user stored in a database as shown in FIG. 3. The processor(s) 410 may also be configured to generate personalized content information by using the user profile information and processed news articles as input to a generative Artificial Intelligence (AI) model as shown in FIG. 3. The processor(s) 410 may also be configured to format the personalized content information into a newsletter tailored to the user for review as shown in FIG. 3.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for generating personalized newsletter, the method comprising:
collecting and processing, by a processor, news articles from various sources;
retrieving, by the processor, user profile information associated with a user stored in a database;
generating, by the processor, personalized content information by using the user profile information and processed news articles as input to a generative Artificial Intelligence (AI) model; and
formatting, by the processor, the personalized content information into a newsletter tailored to the user for review.

2. The method of claim 1, wherein the processor is configured to process the news articles by filtering and categorizing the news articles based on predefined topics and sectors.

3. The method of claim 1, wherein the user profile information comprises user demographic information, financial portfolio data, user interests, user preference information, and financial education level of the user.

4. The method of claim 3, wherein the processor is configured to generate the personalized content information by:
filtering and categorizing the news articles based on the financial portfolio data and user interests; and
generating the personalized content information based on the user profile information and filtered and categorized news articles using the generative AI model.

5. The method of claim 3, further comprising:
modifying, by the processor, acronym usage in the user profile information based on the financial education level of the user and the user preference information.

6. The method of claim 3, wherein a tone and a reporting style of the personalized content information are adjusted according to the user preference information.

7. The method of claim 3, wherein the processor is configured to generate the personalized content information by:
for the news articles being comprised of a plurality of categories, adjusting a tone and a reporting style for each of the plurality of categories based on the user preference information; and
generating a plurality of news segments from the news articles and the user profile information using the generative AI model, each segment of the plurality of news segments is associated with a tone and a reporting style based on the user preference information using the generative AI model,
wherein the personalized content information comprises the plurality of news segments and associated tones and reporting styles.

8. The method of claim 7, wherein tones associated with the plurality of categories are voice tones, and each of the voice tones is associated a voice of a person or a fictional character.

9. The method of claim 3, further comprising:
translating, by the processor, the news articles from a first language to a second language based on the user preference information using the generative AI model,
wherein the processor is configured to generate the personalized content information from the user preference information and translated news articles using the generative AI model.

10. A personalized newsletter generation system, the system comprising:
a database; and
a processor in communication with the database, wherein the processor is configured to:
collect and processing news articles from various sources,
retrieve user profile information associated with a user stored in the database,
generate personalized content information by using the user profile information and processed news articles as input to a generative Artificial Intelligence (AI) model, and
format the personalized content information into a newsletter tailored to the user for review.

11. The system of claim 10, wherein the processor is configured to process the news articles by filtering and categorizing the news articles based on predefined topics and sectors.

12. The system of claim 10, wherein the user profile information comprises user demographic information, financial portfolio data, user interests, user preference information, and financial education level of the user.

13. The system of claim 12, wherein the processor is configured to generate the personalized content information by:
filtering and categorizing the news articles based on the financial portfolio data and user interests; and
generating the personalized content information based on the user profile information and filtered and categorized news articles using the generative AI model.

14. The system of claim 12, wherein the processor is further configured to modify acronym usage in the user profile information based on the financial education level of the user and the user preference information.

15. The system of claim 12, wherein a tone and a reporting style of the personalized content information are adjusted according to the user preference information.

16. The system of claim 12, wherein the processor is configured to generate the personalized content information by:
for the news articles being comprised of a plurality of categories, adjust a tone and a reporting style for each of the plurality of categories based on the user preference information; and
generate a plurality of news segments from the news articles and the user profile information using the generative AI model, each segment of the plurality of news segments is associated with a tone and a reporting style based on the user preference information using the generative AI model,
wherein the personalized content information comprises the plurality of news segments and associated tones and reporting styles.

17. The system of claim 16, wherein tones associated with the plurality of categories are voice tones, and each of the voice tones is associated a voice of a person or a fictional character.

18. The system of claim 12,
wherein the processor is configured to process the news articles by translating the news articles from a first language to a second language based on the user preference information using the generative AI model,
wherein the processor is configured to generate the personalized content information from the user preference information and translated news articles using the generative AI model.
